(19) United States
(12) Patent Application Publication
(10) Pub. No.: US 2020/0064526 A1
(43) Pub. Date: Feb. 27, 2020

(54) DIFFUSER

(71) Applicant: PLATINUM OPTICS TECHNOLOGY INC., TAOYUAN CITY (TW)

(72) Inventors: CHUNG-HAN LU, TAOYUAN CITY (TW); Chun-Yuan Lu, TAOYUAN CITY (TW); Chang-Chih Shih, TAOYUAN CITY (TW)

(21) Appl. No.: 16/542,319

(22) Filed: Aug. 16, 2019

(30) Foreign Application Priority Data
Aug. 22, 2018 (CN) 201810959167.9

(51) Int. Cl. G02B 5/02

(52) U.S. Cl. CPC G02B 5/0242; B32B 27/08; G02B 5/0278; G02B 5/021

(57) ABSTRACT

A diffuser includes a glass material and a plurality of scattering particles. The scattering particles are spread in the glass material, where the scattering particles are inorganic materials. The haze of the diffuser is larger than 99%, whereas the thickness of the diffuser ranges between 100 μm and 350 μm.

### FIELD OF THE INVENTION

The present invention relates to an optical component, and more particularly to a diffuser.

### BACKGROUND OF THE INVENTION

Some existing mobile devices, such as cell phones and tablets, are equipped with auto-brightness screens. This existing mobile device can automatically change the brightness of the screen depending on different light source environments, so that the screen can show images clearly, thereby providing good quality of display. The mobile device is usually equipped with a photo sensor to sense a light source in an environment where the mobile device is located. The mobile device can adjust the brightness of the screen depending on the sensing result of the photo sensor.

Most of the photo sensors are chip packages, which includes a die, a carrier, and an optical assembly. The die and the optical assembly are all mounted on a carrier. The optical assembly usually includes a diffuser, which may be a cosine corrector. The diffuser can receive a plurality of rays at multiple different incident angles, and the rays can pass through the diffuser, where the total intensity of all rays from the diffuser is substantially unaffected by variation in the incident angle. That is, the variation in the sensing result of the photo sensor due to a slight change of the position or the orientation is not large under the condition that the mobile device is kept in the same light source environment, thereby reducing or avoiding deviations in the sensing result of the photo sensor.

An existing mobile device has a small size and a thin thickness, so that an accommodating space inside the mobile device is limited. Hence, the photo sensor needs enough size to be installed in the mobile device. That is, the diffuser of the optical assembly has to be thin enough, for example, less than 500 μm, to help to install the photo sensor in the mobile device. In order to make the diffuser thin enough, most of the diffusers of the existing mobile devices are thin films that are made of polymer materials, such as resin films, so that the diffuser can be installed in the mobile device.

Since most of the photo sensors are chip packages, manufacture of the photo sensor needs reflow soldering. In the reflow soldering, the diffuser enters a reflow oven. The temperature inside the reflow oven is above 200° C. However, since most of the diffusers are made of polymer materials, the existing diffusers usually lack good heat resistance. Hence, the diffuser is difficultly resistant to high heat above 200° C. in the reflow soldering, so that the diffuser is easy to be deformed or deteriorated.

### SUMMARY OF THE INVENTION

The present invention provides a diffuser having a thickness of less than 500 μm and a good haze.

The diffuser provided by the present invention includes a glass material and a plurality of scattering particles. The scattering particles are inorganic materials and spread in the glass material. The haze of the diffuser is larger than 99%, whereas the thickness of the diffuser ranges between 100 μm and 350 μm.

Since the diffuser of the present invention has the thickness of less than 500 μm, such as between 100 μm and 350 μm, the diffuser is able to be installed in the device having a small accommodating space, for example, a cell phone or a tablet. Therefore, the diffuser of the present invention is suitable for use in the photo sensor of the mobile device, so that it can help the photo sensor install in the existing mobile device having a small size and a thin thickness, thereby satisfying the trend of thinning the mobile device.

### BRIEF DESCRIPTION OF THE DRAWINGS

The present invention will become more readily apparent to those ordinarily skilled in the art after reviewing the following detailed description and accompanying drawings, in which:

FIG. 1 is a cross-sectional view of a diffuser in accordance with an embodiment of the present invention.

### DETAILED DESCRIPTION OF EMBODIMENTS

The present invention will now be described more specifically with reference to the following embodiments. It is to be noted that the following descriptions of embodiments of this invention are presented herein for purpose of illustration and description only. It is not intended to be exhaustive or to be limited to the precise form disclosed.

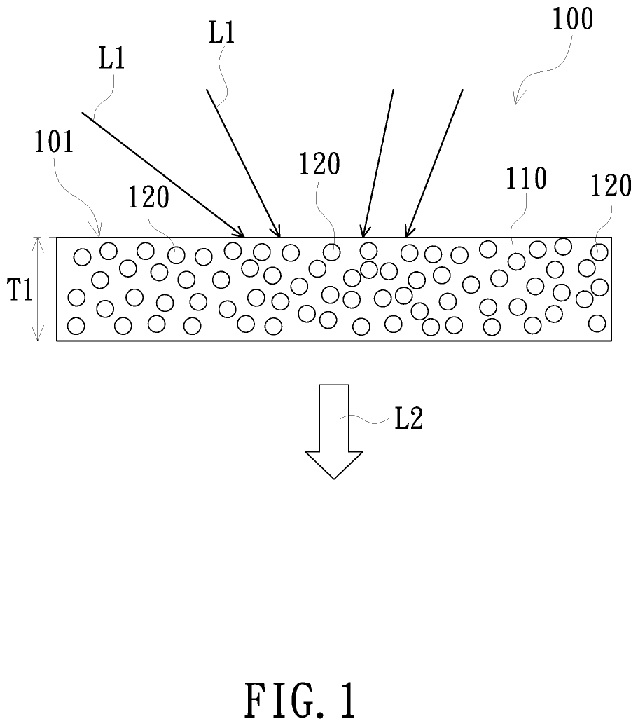

FIG. 1 is a cross-sectional view of a diffuser in accordance with an embodiment of the present invention. Referring to FIG. 1, the diffuser 100 includes a glass material 110 and a plurality of scattering particles 120, where the scattering particles 120 are all inorganic materials and spread in the glass material 110. Thus, all of the ingredients of the diffuser 100 can be inorganic materials. Compared with organic materials, the diffuser 100 is resistant to ultraviolet (UV) light and not easy to deteriorate after long irradiation with UV light. The haze of the diffuser 100 is larger than 99%. The thickness T1 of the diffuser 100 ranges between 100 μm and 350 μm, for example, between 150 μm and 300 μm.

Since the thickness T1 of the diffuser 100 is less than 500 μm (e.g. between 100 μm and 350 μm), the diffuser 100 has the sufficiently thin thickness T1 to help the diffuser 100 install in the existing mobile device, so that the diffuser 100 is suitable for use in the photo sensor of the mobile device. The diffuser 100 can be used as a cosine corrector. In addition to mobile devices, the diffuser 100 also can be applied to some optical devices, such as a photometer. For example, the diffuser 100 can be installed in an optical fiber connector, such as SMA (Sub Miniature A) or FC (Ferrule Connector), so that the rays of light received by the diffuser 100 can be transmitted to a photo sensing chip, such as charge-coupled device (CCD) or complementary metal-oxide-semiconductor (CMOS), through an optical fiber.

In addition, it is worth noting that the diffuser 100 can be connected to a light emitting device and used for scattering the rays of light to diverge or uniform the light from the light emitting device, in which the light emitting device is such as a light emitting diode (LED). Thus, the diffuser 100 also can be applied to the light emitting device, such as a light fixture, so that the diffuser 100 is not limited to the use of the photo sensor.

The glass-transition temperature (Tg) of the glass material 110 may range between 500° C. and 670° C. The diffuser 100 can be resistant to a temperature between 200° C. and 500° C. That is, when the temperature of the diffuser 100 ranges between 200° C. and 500° C., the haze of the diffuser 100 is still larger than 99%. Accordingly, even if the diffuser 100 is in a high temperature environment, for example, the inside of a reflow oven during the reflow soldering, the diffuser 100 can keep a certain or constant haze to maintain the desired optical effect, thereby reducing or avoiding deviations in the sensing result of the photo sensor.

A particle size of each scattering particle 120 ranges between 5 μm and 60 μm, and a weight percentage of these scattering particles 120 may range between 3% and 10%. The refractive index of the glass material 110 is less than the refractive index of each of the scattering particles 120. For example, the refractive index of the glass material 110 may range between 1.4 and 1.6, whereas the refractive index of each of the scattering particles 120 may range between 1.7 and 2.61. The glass material 110 may include at least one kind of ingredient selected from SiO₂, B₂O₃, Al₂O₃, ZnO, CaO, BaO, SrO, MgO, Na₂O, K₂O, and ZrO. That is, the glass material 110 may include any combination of the above ingredients.

SiO₂ and B₂O₃ can form a network structure of glass. SiO₂ can improve thermal stability, chemical stability, and mechanical strength, whereas B₂O₃ can be used as flux to reduce a melting temperature and reduce viscosity to help ingredients homogeneous. ZnO, CaO, BaO, SrO, MgO, Na₂O, and K₂O are all modifiers outside the network structure, in which ZnO and MgO can improve stability and weatherability, and ZnO can reduce coefficient of thermal expansion (CTE). CaO, BaO, and SrO can reduce the viscosity and help ingredients melted and homogeneous. Na₂O and K₂O can be used as flux to reduce the melting temperature. Al₂O₃ can improve both the thermal stability and the mechanical strength and increase the refractive index, whereas ZrO can improve the chemical stability.

The ingredients of the scattering particles 120 with the refractive index ranging between 1.7 and 2.61 include at least one of Al₂O₃, ZnO, CaO, MgO, BaO, SrO, ZrO₂, Ta₂O₅, Y₂O₃, La₂O₃, GeO₂, Nb₂O₅, and TiO₂. For example, all of the scattering particles 120 can be made of the same material. Alternatively, some scattering particles 120 can be made of one kind of material (e.g. ZnO), and other scattering particles 120 can be made of another at least one kind of material (e.g. MgO).

A following Table (1) lists eight samples 1 to 8 based on the diffuser 100 made by employing different ingredients and ratios.

TABLE 1

| | Sample 1 | Sample 2 | Sample 3 | Sample 4 | Sample 5 | Sample 6 | Sample 7 | Sample 8 |
|---|---|---|---|---|---|---|---|---|
| SiO₂ weight | 16.07 | 13.48 | 21.19 | 11.54 | 15.92 | 14.98 | 13.91 | 36.45 |
| percentage (%) | | | | | | | | |
| B₂O₃ weight | 43.5 | 36.49 | 57.35 | 31.23 | 43.09 | 24.66 | 31.49 | 39.9 |
| percentage (%) | | | | | | | | |
| Al₂O₃ weight | | | | | 7.91 | 6.22 | 18.06 | |
| percentage (%) | | | | | | | | |
| ZnO weight | | | | | 8.25 | 23.13 | 11.3 | 9.46 |
| percentage (%) | | | | | | | | |
| MgO weight | | | 21.46 | | | | | |
| percentage (%) | | | | | | | | |
| SrO weight | | 50.03 | | | | | | |
| percentage (%) | | | | | | | | |
| CaO weight | 40.43 | | | | 24.83 | | | |
| percentage (%) | | | | | | | | |
| BaO weight | | | | 57.23 | | | | |
| percentage (%) | | | | | | | | |
| Na₂O weight | | | | | | | | 6.16 |
| percentage (%) | | | | | | | | |
| K₂O weight | | | | | | 31.01 | 22.39 | 8.03 |
| percentage (%) | | | | | | | | |
| ZrO₂ weight | | | | | | | 2.85 | |
| percentage (%) | | | | | | | | |
| RO weight | 40.43 | 50.03 | 21.46 | 57.23 | 24.83 | | | |
| percentage (%) | | | | | | | | |
| R₂O weight | | | | | | 31.01 | 22.39 | 14.19 |
| percentage (%) | | | | | | | | |
| Kind and | ZnO | ZnO | MgO | Al₂O₃ | Al₂O₃ | CaO | BaO | ZrO₂ |
| weight ratio (%) | 3% | 6.0 | 10% | 5% | 10% | 4.5% | 8% | 9% |
| of scattering | | | | | | | | |
| particles | | | | | | | | |
| Sintering time | 800° C. | 700° C. | 750° C. | 800° C. | 800° C. | 650° C. | 700° C. | 850° C. |
| and temperature | 0.5 hour | 2 hours | 1.5 hours | 2 hours | 0.5 hour | 1 hour | 1 hour | 1 hour |
| Glass-transition | 611 | 632 | 672 | 596 | 621 | 501 | 524 | 510 |
| temperature | | | | | | | | |
| (Tg, ° C.) | | | | | | | | |
| Soften | 642 | 673 | 727 | 635 | 661 | 542 | 588 | 554 |
| temperature | | | | | | | | |
| (Ts,° C.) | | | | | | | | |
| CTE | 8.24 | 8.48 | 5.17 | 9 | 6.48 | 11.02 | 8.22 | 7.47 |
| Refractive | 1.533 | 1.563 | 1.527 | 1.571 | 1.515 | 1.472 | 1.509 | 1.458 |
| index of glass | | | | | | | | |
| Young's | 58 | 72 | 61 | 62 | 66 | 55 | 50 | 75 |
| modulus (Gpa) | | | | | | | | |
| Hardness (Hk) | 502 | 521 | 490 | 482 | 495 | 455 | 490 | 545 |
| (Kgf/mm²) | | | | | | | | |
| Thickness | 100 | 200 | 300 | 200 | 200 | 250 | 150 | 350 |
| T1 (μm) | | | | | | | | |
| Density (g/cm²) | 2.41 | 2.32 | 2.56 | 2.3 | 2.49 | 2.62 | 2.47 | 2.58 |
| Haze (%) | 99.54 | 99.56 | 99.53 | 99.52 | 99.55 | 99.55 | 99.54 | 99.53 |
| Parallel | 0.25 | 0.24 | 0.2 | 0.26 | 0.22 | 0.23 | 0.24 | 0.18 |
| transmittance | | | | | | | | |
| (P.T, %) | | | | | | | | |
| Total | 55.46 | 55.46 | 42.79 | 55.44 | 49.35 | 51.03 | 52.35 | 38.25 |
| transmittance | | | | | | | | |
| (T.T, %) | | | | | | | | |
| Diffusion | 55.21 | 55.22 | 49.59 | 54.18 | 49.13 | 50.8 | 52.11 | 38.07 |
| transmittance | | | | | | | | |
| (Dif, %) | | | | | | | | |
| Average | 39.26 | 35.6 | 28.98 | 32.78 | 31.74 | 32.65 | 34.47 | 20.34 |
| transmittance | | | | | | | | |
| over wavelength | | | | | | | | |
| range of 400 nm | | | | | | | | |
| to 700 nm (%) | | | | | | | | |
| Variation in | 0.345 | 0.19 | 0.156 | 0.21 | 0.174 | 0.202 | 0.238 | 0.165 |
| transmittance at | | | | | | | | |
| incident angle | | | | | | | | |
| of 0 to 45° | | | | | | | | |
| over wavelength | | | | | | | | |
| range of 400 nm | | | | | | | | |
| to 700 nm (%) | | | | | | | | |
| Variation in | 0.199 | 0.206 | 0.268 | 0.194 | 0.213 | 0.228 | 0.182 | 0.281 |
| reflectance at | | | | | | | | |
| incident angle | | | | | | | | |
| of 0 to 45° | | | | | | | | |
| over wavelength | | | | | | | | |
| range of 400 nm | | | | | | | | |
| to 700 nm (%) | | | | | | | | |
| X value in | 0.1542 | 0.1552 | 0.1551 | 0.1548 | 0.155 | 0.1553 | 0.1545 | 0.1551 |
| CIE 1931 | | | | | | | | |
| chromaticity | | | | | | | | |
| diagram | | | | | | | | |
| Surface | 553 | 620 | 580 | 700 | 611 | 591 | 688 | 650 |
| roughness (nm) | | | | | | | | |

In the above Table (1), the RO weight percentage means the total weight percentage of MgO, CaO, SrO, and BaO, whereas the R₂O weight percentage means the total weight percentage of Na₂O and K₂O. The refractive index of glass in Table (1) means the refractive index, which the glass shows and is measured by a prism coupler. The diffuser 100 has a surface 101. The surface roughness in Table (1) means a surface roughness of the surface 101, for example. In addition, all of the samples 1 to 8 based on the diffuser 100 pass “85° C./85% RH 1000 HR” reliability test (e.g. Temperature Humidity Test, THT). The “85° C./85% RH 1000 HR” means that the samples 1 to 8 are placed in a harsh environment at a temperature of 85° C. and a relative humidity (RH) of 85% for 1000 hours. After the samples 1 to 8 are placed in the harsh environment for 1000 hours, no irrecoverable exterior defect appears in any of samples 1 to 8, and the basic optical effects of the samples 1 to 8 are unaffected.

Referring to the above Table (1), the diffuser 100 corresponds to an X coordinate of between 0.1543 and 0.1553 in CIE 1931 chromaticity diagram, whereas the roughness of the surface 101 of the diffuser 100 may range between 550 nm and 700 nm. With regard to mechanical strength, each of the samples 1 to 8 based on the diffuser 100 has Young's modulus ranging between 50 Gpa and 75 Gpa, and the hardness (HK) ranging between 450 Kgf/mm² and 550 Kgf/mm². Moreover, regarding the glass materials 110 of the samples 1 to 8, the weight percentage range of each ingredient is listed as the following Table (2).

TABLE 2

| | Range of weight |
|---|---|
| | percentage |
| SiO₂ | 11%~37% |
| B₂O₃ | 24%~58% |
| Al₂O₃ | 0%~19% |
| ZnO | 0%~24% |
| MgO | 0%~22% |
| SrO | 0%~51% |
| CaO | 0%~41% |
| BaO | 0%~60% |
| Na₂O | 0%~7% |
| K₂O | 0%~32% |
| ZrO₂ | 0%~3% |
| RO | 0~58% |
| (i.e. total weight percentage of | |
| MgO, CaO, SrO, and BaO) | |
| R₂O | 0~32% |
| (i.e. total weight percentage of | |
| Na₂O and K₂O) | |

With regard to optical transmittance, the total transmittance (T.T) of each of the samples 1 to 8 based on the diffuser 100 ranges between 35% and 56%. The parallel transmittance (P.T) is less than 0.3%, whereas the diffusion transmittance (Dif) ranges between 35% and 55%, where the T.T of each of the samples 1 to 8 is equal to P.T plus Dif both thereof, as shown in Table (1). The transmittances of the samples 1 to 8 over the wavelength range of 400 nm to 700 nm range between 20% and 40%. In the samples 1 to 8, the sample 1 has the largest transmittance: 39.26%, and the sample 8 has the smallest transmittance: 20.34%.

It is worth noting that the transmittance of the diffuser 100 over the wavelength range of 400 nm to 700 nm ranges between 20% and 40%, but the haze of the diffuser 100 ranges between 99.5% and 99.6%. That is, there are the largest transmittance difference of 20% and a haze transmittance of 0.1% in the samples 1 to 8. For example, the samples 1 and 8 each have a haze about 99.5%, but the samples 1 and 8 have the transmittances of 39.26% and 20.34% respectively. Therefore, under a condition of requiring the haze of 99% or more, the diffuser 100 can be designed to have varied transmittances for diverse product demands.

In addition, each of the variations in both transmittance and reflectance of the diffuser 100 is less than 1% when rays of light over a wavelength range of 400 nm to 700 nm are incident to the diffuser 100 at an incident angle of 0 to 45 degrees. Accordingly, when the diffuser 100 in a light source environment receives a plurality of external rays L1 of light, the total intensity of light L2 emitted from the diffuser 100 with the variation in the incident angle of the external ray L1 does not change largely, so that the photo sensor does not get large variation in the sensing result due to a slight change of the position or the orientation of the diffuser 100, thereby reducing or avoiding deviations in the sensing result of the photo sensor.

The diffuser 100 is mainly made by second sintering. Specifically, in manufacture of the diffuser 100, first, an initial glass is made. The initial glass can be made by sintering, in which the sintering temperature may range between 1200° C. and 1400° C., and the ingredients of the initial glass may be the same as the ingredients included by the glass material 110, such as SiO₂, B₂O₃, Al₂O₃, ZnO, CaO, BaO, SrO, MgO, Na₂O, K₂O and ZrO₂, or any combination of the preceding ingredients.

Next, the initial glass is crushed, and then ground into a glass powder, in which the particle size of the glass powder is about 80 μm or less. Then, the glass powder and a plurality of scattering particles 120 are mixed together and compressed to form a compressed tablet. The weight percentage of the scattering particles 120 ranges between 3% and 10%, and the compressing process can be performed by using a hydraulic press. Next, the compressed tablet is heated, where the temperature of heating the compressed tablet can range between 650° C. and 850° C., and the time of heating may be two hours. Afterward, the compressed tablet cools off naturally. Then, the compressed tablet is cut and polished in sequence to form a sheet having a thickness ranging about between 100 μm and 350 μm. So far, the diffuser 100 is basically completed.

Compared with the sintering temperature of the initial glass, the temperature of heating the compressed tablet is obviously lower, and the scattering particles 120 can not melt in the temperature range of heating the compressed tablet. In other words, after heating the compressed tablet, each of the scattering particles 120 basically remains in its original shape. That is, there is a boundary existing between the scattering particle 120 and the glass material 110. Therefore, at least one peak signal corresponding to the composition of the scattering particle 120 can be detected by performing X-Ray diffraction on the compressed tablet after heated or the complete diffuser 100.

While the invention has been described in terms of what is presently considered to be the most practical and embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A diffuser comprising:
a glass material:
a plurality of scattering particles spread in the glass material, wherein the scattering particles are inorganic materials,
wherein a haze of the diffuser is larger than 99%, whereas a thickness of the diffuser ranges between 100 μm and 350 μm.

2. The diffuser of claim 1, wherein the haze of the diffuser is still larger than 99% when a temperature of the diffuser ranges between 200° C. and 500° C.

3. The diffuser of claim 1, wherein a total transmittance (T.T) of the diffuser ranges between 35% and 56%.

4. The diffuser of claim 1, wherein a parallel transmittance (P.T) is less than 0.3%.

5. The diffuser of claim 1, wherein a transmittance of the diffuser over a wavelength range of 400 nm to 700 nm ranges between 20% and 40%.

6. The diffuser of claim 1, wherein a refractive index of the glass material is less than a refractive index of each of the scattering particles.

7. The diffuser of claim 6, wherein the refractive index of the glass material ranges between 1.4 and 1.6, whereas the refractive index of each of the scattering particles ranges between 1.7 and 2.61.

8. The diffuser of claim 1, wherein a plurality of ingredients of the scattering particles comprises at least one of Al₂O₃, ZnO, CaO, MgO, BaO, SrO, ZrO₂, Ta₂O₅, Y₂O₃, La₂O₃, GeO₂, Nb₂O₅, and TiO₂.

9. The diffuser of claim 1, wherein a particle size of each of the scattering particles ranges between 5 μm and 60 μm.

10. The diffuser of claim 1, wherein a weight percentage of the scattering particles ranges between 3% and 10%.

11. The diffuser of claim 1, wherein a variation in transmittance of the diffuser is less than 1% when a ray of light over a wavelength range of 400 nm to 700 nm is incident to the diffuser at an incident angle of 0 to 45 degrees.

12. The diffuser of claim 1, wherein a variation in reflectance of the diffuser is less than 1% when a ray of light over a wavelength range of 400 nm to 700 nm is incident to the diffuser at an incident angle of 0 to 45 degrees.

13. The diffuser of claim 1, wherein a glass-transition temperature (Tg) of the glass material ranges between 500° C. and 670° C.

14. The diffuser of claim 1, wherein a Young's modulus of the diffuser ranges between 50 Gpa and 75 Gpa.

15. The diffuser of claim 1, wherein a hardness of the diffuser ranges between 450 Kgf/mm² and 550 Kgf/mm².

16. The diffuser of claim 1, wherein a surface roughness of the diffuser ranges between 550 nm and 700 nm.
